(19) United States
(12) Patent Application Publication
(10) Pub. No.: US 2016/0318162 A1
(43) Pub. Date: Nov. 3, 2016

(54) HAND TOOL BIT

(71) Applicant: Tuo-Jen Chen, Taichung (TW)

(72) Inventor: Tuo-Jen Chen, Taichung (TW)

(21) Appl. No.: 14/697,632

(22) Filed: Apr. 28, 2015

(51) Int. Cl. B25B 15/00

(52) U.S. Cl. CPC B25B 15/001

(57) ABSTRACT

A hand tool bit includes a bit having a driving end and a connection end which is sized to be inserted into the hexagonal recess of a socket. The connection end has a first face and a second face formed on two opposite sides of the body of the bit, and a first contact portion and a second contact portion formed on the other two opposite sides of the body of the bit. The first and second contact portions contact two of the six sides of the hexagonal recess of the socket.

### BACKGROUND OF THE INVENTION

1. Fields of the invention

The present invention relates to a hand tool bit, and more particularly, to a hand too bit with compact size and is easily used.

2. Descriptions of Related Art

The conventional hand tool bit is disclosed in FIG. 1, and comprises body 1 with a driving end 101 and a connection end 102 on two ends thereof A neck 103 is connected between the driving end 101 and the connection end 102. The driving end 101 is designed to drive an object such as a bolt 2 which may have different recess 202 in the head 201. Therefore, the driving end 101 has different sizes to drive different bolts 2. The connection end 102 is designed to be connected with a hand tool such as a socket 3 which then is rotated to let the driving end 101 to lock or unlock the bolt 2.

As shown in FIG. 2, the connection end 102 is used to be inserted into a hexagonal recess 301 (6.35 mm) of the socket 3, so that all of the hand tool bits have to have a hexagonal connection end 102, regardless of the size of the driving end 101.

Because the connection end 102 can only be made to be a hexagonal end to be connected with the socket 3, so that no matter what size of the driving end 101 and the neck 103 is changed, the hexagonal connection end 102 cannot be changed. In other words, the packing boxes or the storage spaces for the hand tool bits have to have a hexagonal space for receiving the connection end 102. In some situations, the hexagonal connection end 102 restricts the shapes of the hand tool bits.

As shown in FIGS. 3 and 4, some hand tool bits are designed to have a space 104 in the body 1 to save the weight while the strength is maintained. Nevertheless, the conventional shape and size of the hand tool bit are not changed, and the space 104 requires further manufacturing cost.

FIGS. 5, 6 and 7 show two different tool boxes 4, 5 which have receiving spaces 401, 501 to accommodate more hand tool bits. However, the problem of the weight of the hand tool bits does not improved. The weight of the tool box will be increased along with more hand tool bits are carried.

FIG. 8 shows that a hand tool 6 has a storage space 601 defined in the handle thereof, there are multiple receiving recesses 602 are formed to receive the hand tool bits. Again, the weight of the bits is not changed, and the size of the storage space 601 affects the number of the hand tool bits that can be carried.

FIGS. 9 and 10 show that the hand tool bits 7, 8 each have a colored portion 701/801 to provide distinguishing feature to the users. The colored portions 701, 801 can be made by different methods which needs special machine and a high cost is required.

Furthermore, as shown in FIG. 9, the colored portion 701 has to be formed in a recessed groove in the body 7, and the recessed groove requires extra machining cost. The colored portions 701, 801 each are made in a small area of the bits 7, 8, this has certain difficulties.

The present invention intends to provide a hand tool bit which has less weight to improve the shortcomings mentioned above.

### SUMMARY OF THE INVENTION

The present invention relates to a hand tool bit and comprises a bit having a driving end and a connection end. The connection end is sized to be inserted into a hexagonal recess of a socket. The connection end has a first face and a second face formed on two opposite sides of the body of the bit. A first contact portion and a second contact portion are formed on the other two opposite sides of the body of the bit. The first contact portion has a first inclined face and a second inclined face. The first and second inclined faces intersect with each other at an angle. The second contact portion has a third inclined face and a fourth inclined face. The third and fourth inclined faces intersect with each other at an angle. The width of each of the first, second, third and fourth inclined faces is smaller than or equal to ⅔ of any of the six sides of the hexagonal recess of the socket.

Preferably, the first contact portion and the second contact portion contact any two inner corners of the hexagonal recess of the socket.

Alternatively, the present invention provides a hand tool bit which comprises a bit having a driving end and a connection end which is sized to be inserted into a hexagonal recess of a socket. The connection end has a first face and a second face formed on two opposite sides of the body of the bit. A first contact portion and a second contact portion are formed on the other two opposite sides of the body of the bit. The first contact portion and the second contact portion each are a flat surface. The width of each of the first and second contact portions is smaller than or equal to the width of any of the six sides of the hexagonal recess of the socket.

Preferably, the first contact portion and the second contact portion contact any two of the six sides of the hexagonal recess of the socket.

Preferably, the first contact portion has a third inclined face and a fourth inclined face on two sides thereof The second contact portion has a fifth inclined face and a sixth inclined face on two sides thereof The width of each of the third, fourth, fifth and sixth inclined faces is smaller than or equal to ½ of any of the six sides of the hexagonal recess of the socket.

Preferably, the first contact portion and the second contact portion contact any two sides of the hexagonal recess of the socket. The third and fourth inclined faces contact two sides between which the side that the first contact portion contacts is located. The fifth and sixth inclined faces contact two sides between which the side that the second contact portion contacts is located.

The primary object of the present invention is to provide a hand tool bit that is smaller than the conventional hand tool bit.

Another object of the present invention is to provide a hand tool bit that is smaller than the conventional hand tool bit so as to save smaller storage space.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the conventional hand tool bit;

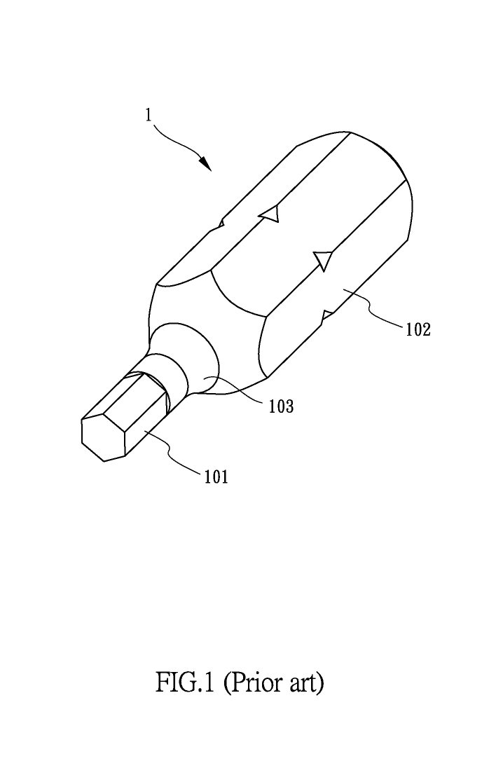

FIG. 2 shows the conventional hand tool bit and a socket;

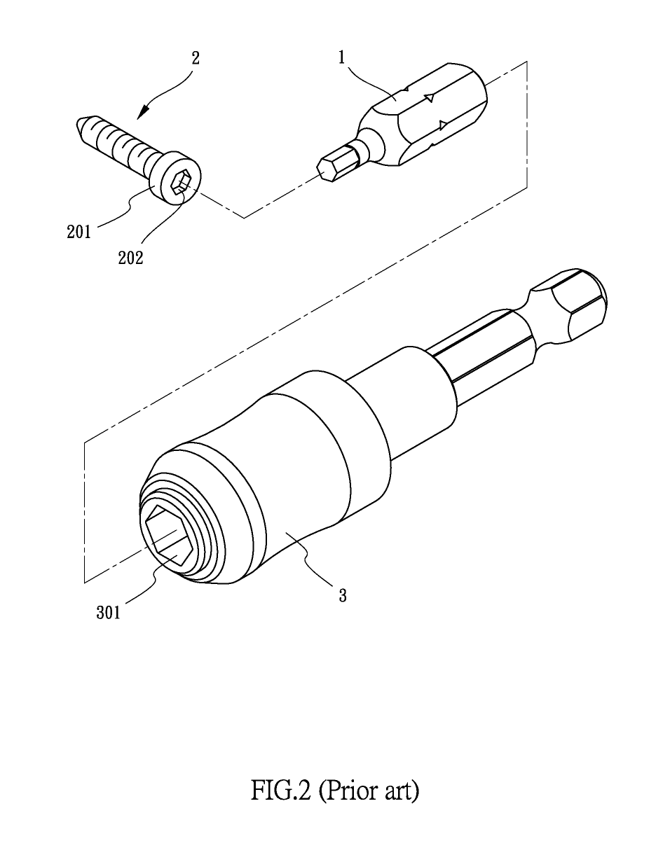

FIG. 3 shows another conventional hand tool bit;

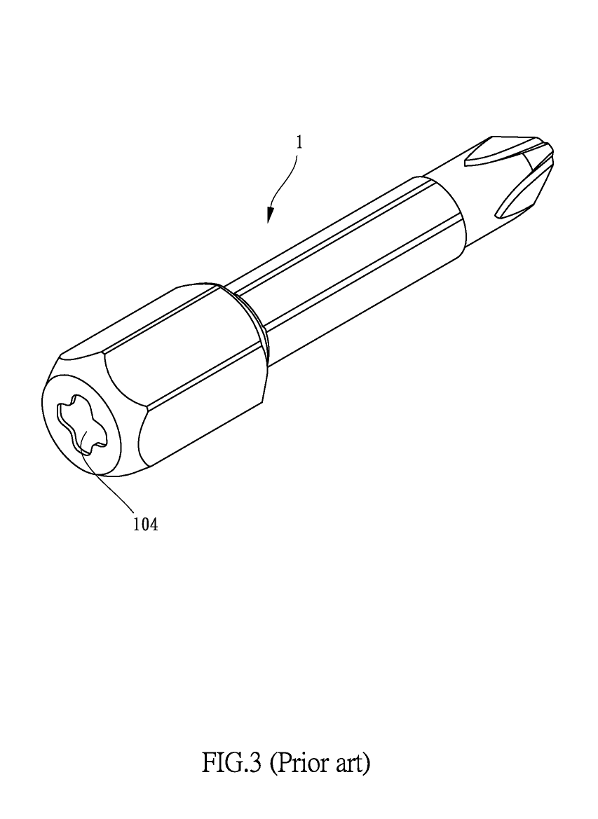

FIG. 4 shows the cross sectional view of the conventional hand tool bit in FIG. 3;

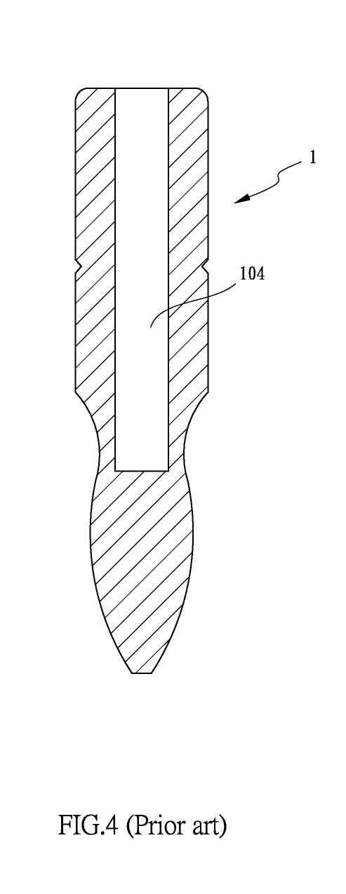

FIG. 5 shows the conventional hand tool bit and a tool box;

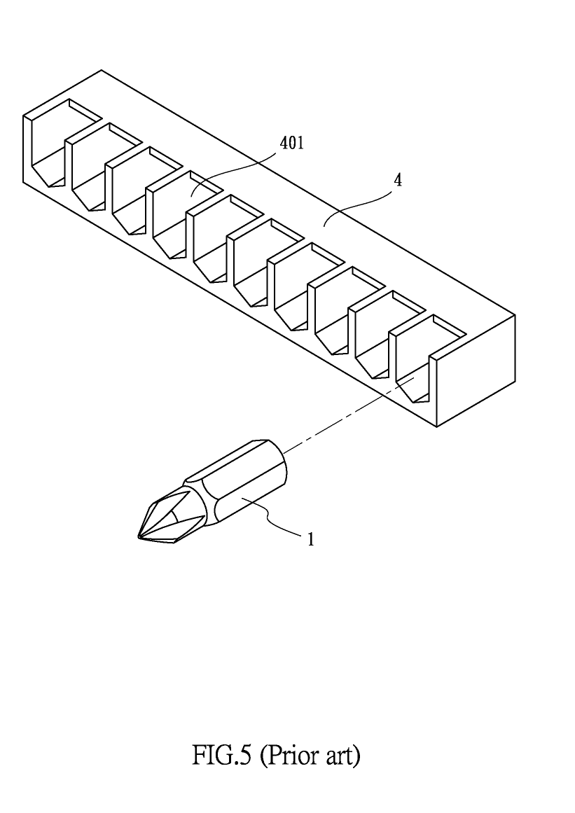

FIG. 6 shows multiple conventional hand tool bits and a tool box;

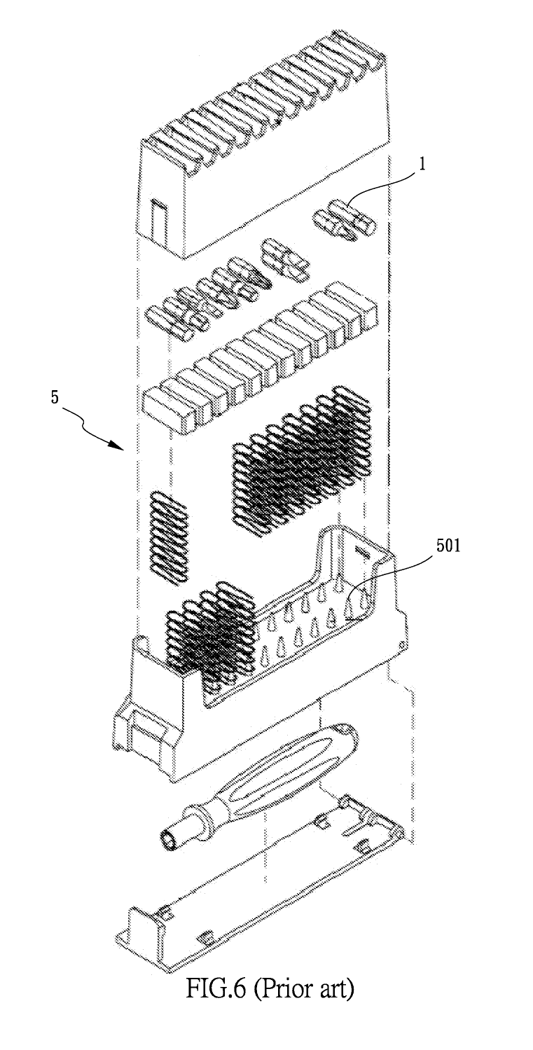

FIG. 7 is a cross sectional view of the conventional hand tool bits and the tool box in FIG. 6;

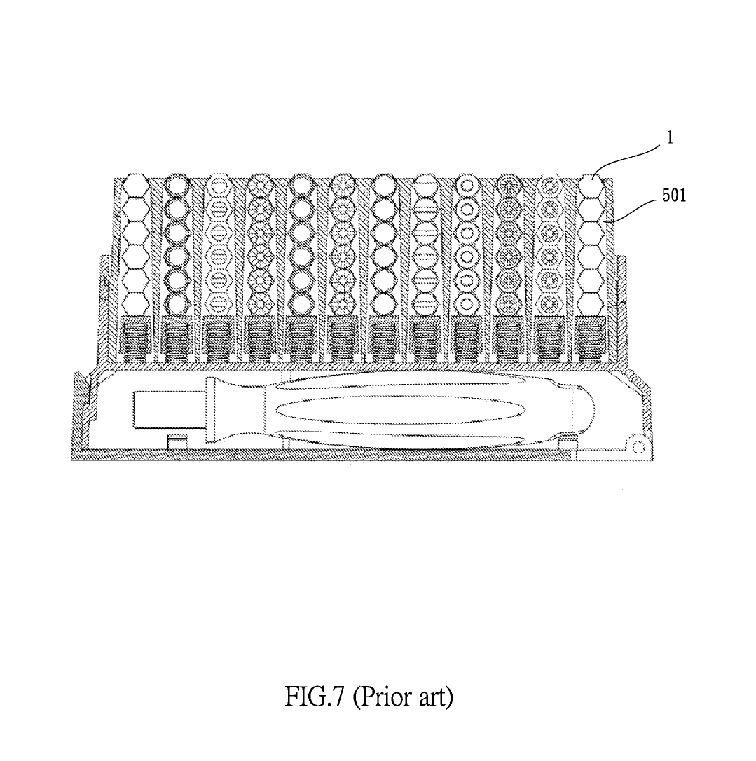

FIG. 8 shows a conventional hand tool bit and a hand tool with a storage space in the handle;

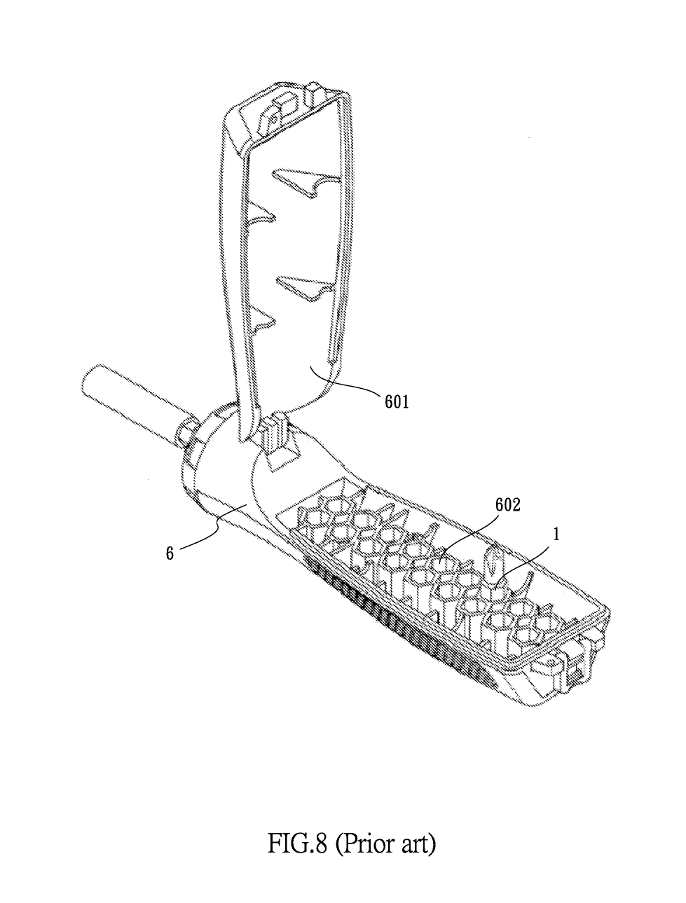

FIG. 9 shows the conventional hand tool bit with a colored portion;

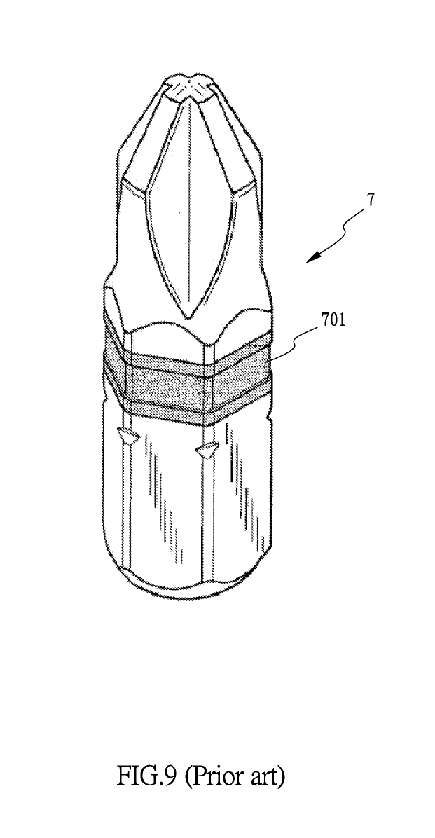

FIG. 10 shows another conventional hand tool bit with a colored portion;

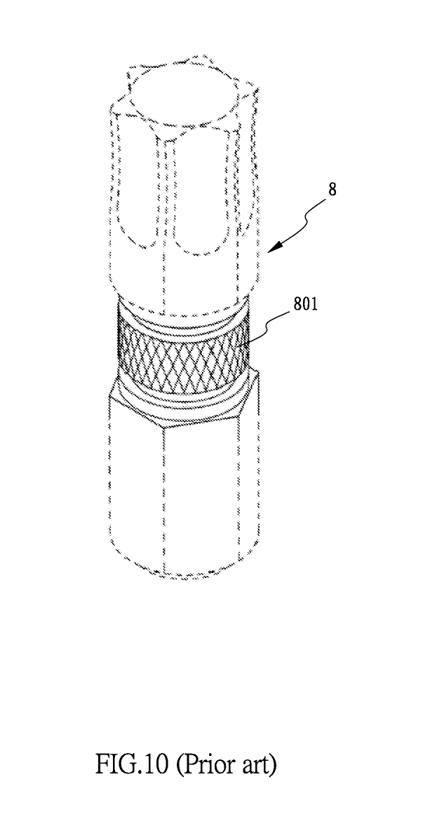

FIG. 11 is a first embodiment of the hand tool bit of the present invention;

FIG. 12 is an end cross sectional view to show that the hand tool bit of the present invention is inserted in a hexagonal recess of a socket;

FIG. 13 is a second embodiment of the hand tool bit of the present invention;

FIG. 14 is an end cross sectional view to show that the hand tool bit of the present invention in FIG. 13 is inserted in a hexagonal recess of a socket;

FIG. 15 is a third embodiment of the hand tool bit of the present invention;

FIG. 16 is an end cross sectional view to show that the hand tool bit of the present invention in FIG. 15 is inserted in a hexagonal recess of a socket, and

FIG. 17 shows that the hand tool bits of the present invention require smaller space than the conventional hand tool bits.

### DETAILED DESCRIPTION OF THE PREFERRED EMBODIMENT

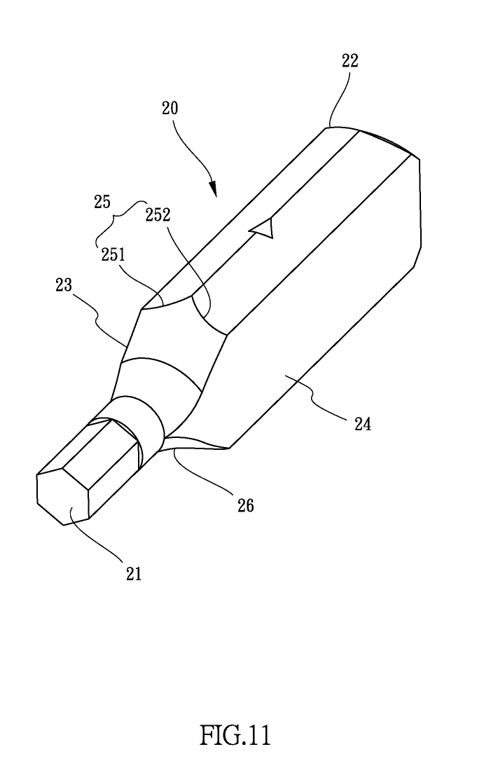

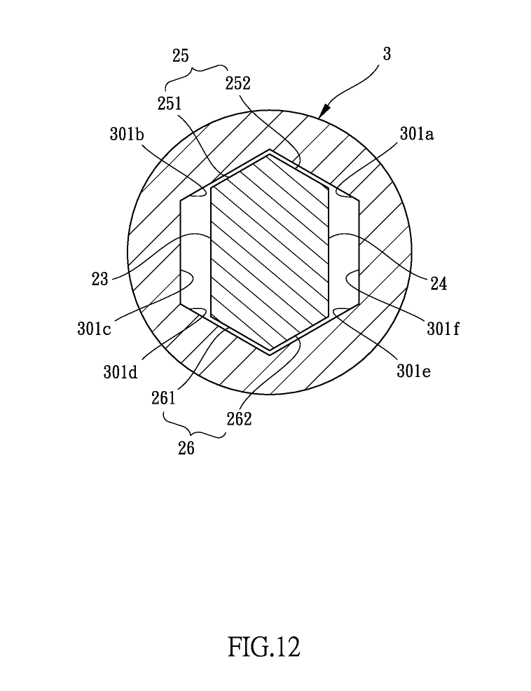

Referring to FIGS. 11 to 12, the hand tool bit of the present invention comprises a bit 20 having a driving end 21 and a connection end 22 which is sized to be inserted into a hexagonal recess 301 of a socket 3. The hexagonal recess 301 of the socket 3 includes six sides 301a to 301f. The driving end 21 is able to be connected with an object such as a bolt (not shown). The bit 20 is rotated when the connection end 22 is connected with the socket 3, and the socket 3 rotates.

The connection end 22 has a first face 23 and a second face 24 formed on two opposite sides of the body of the bit 20. A first contact portion 25 and a second contact portion 26 are formed on the other two opposite sides of the body of the bit 20. The first contact portion 25 has a first inclined face 251 and a second inclined face 252. The first and second inclined faces 251, 252 intersect with each other at an angle. The second contact portion 26 has a third inclined face 261 and a fourth inclined face 262. The third and fourth inclined faces 261, 262 intersect with each other at an angle. The width of each of the first, second, third and fourth inclined faces 251, 252, 261, 262 being smaller than or equal to ⅔ of any of the six sides of the hexagonal recess 301 of the socket 3. It is noted that the connection end 22 of the bit 20 includes the first face 23 and the second face 24, and the first contact portion 25 and the second contact portion 26, so that the size and height of the connection end 22 is smaller than the connection end of the conventional bits. The first and second contact faces 25, 26 of the connection end 22 of the present invention contact the sides 301a, 301b, 301d and 301e of the hexagonal recess 301 of the socket 3, so that the bit 20 of the present invention can be cooperated with the existed socket without any amendment. The connection end 22 of the present invention is only ⅔ of the hexagonal recess 301 of the conventional socket 3. In other word, the bit 20 of the present invention is only ⅔ weight and volume of the conventional bit.

The bit 20 of the present invention does not need to remove material from the axial portion of the bit 20 so that the strength is maintained, and the manufacturing process is simplified. The conventional tool box can receive more bits 20 of the present invention.

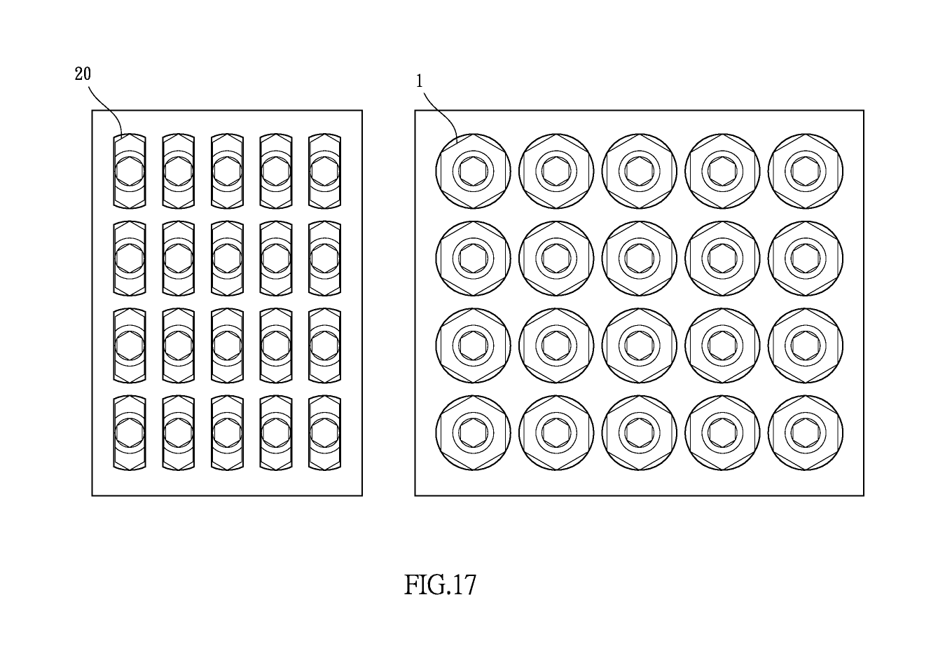

As shown in FIG. 17, assume that the tool box is made according to the shape and size of the connection end 22 of the bit 20 of the present invention, then the number of the bits 20 to be stored is more than the number of the conventional bits to be stored in the tool box.

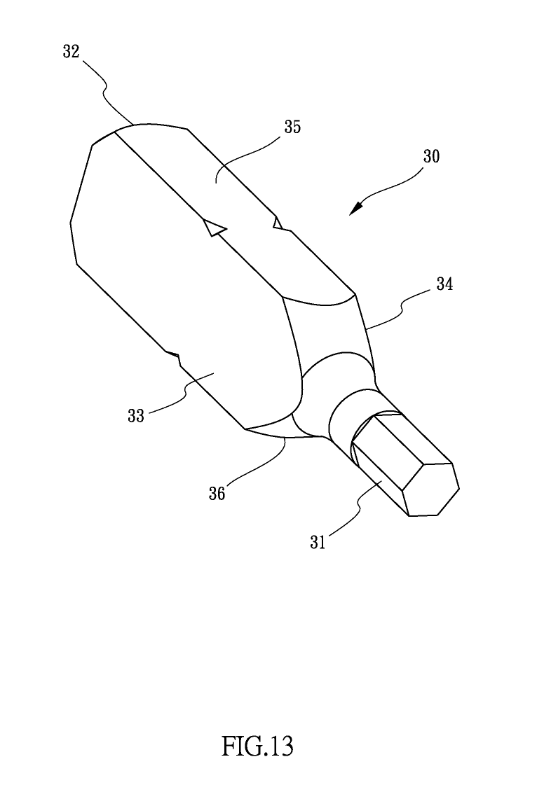

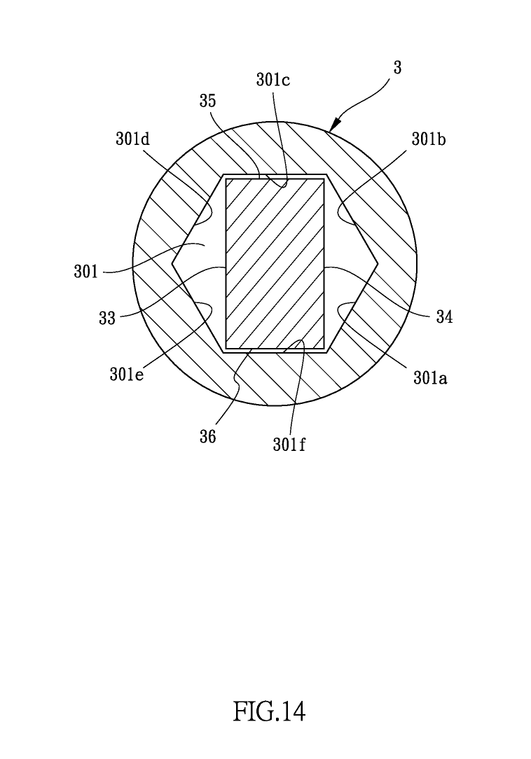

FIGS. 13 and 14 show the second embodiment of the bit 30 of the present invention. The bit 30 has a driving end 31 and a connection end 32 which is sized to be inserted into a hexagonal recess 301 of a socket 3. The connection end 32 has a first face 33 and a second face 34 formed on two opposite sides of a body of the bit 30. A first contact portion 35 and a second contact portion 36 are formed on the other two opposite sides of the body of the bit 20. The first contact portion 35 and the second contact portion 36 each are a flat surface. The width of each of the first and second contact portions 35, 36 is smaller than or equal to the width of any of six sides 301a to 301f of the hexagonal recess 301 of the socket 3.

When in use, the connection end 32 is inserted into the hexagonal recess 301 of the socket 3. The first contact portion 35 and the second contact portion 36 contact any two sides 301a to 301f of the hexagonal recess 301 of the socket 3. When the socket 3 is rotated, the driving end 31 of the bit 30 tightens or loosens the object such as a bolt. The connection end 32 is smaller than the connection end of the conventional bits.

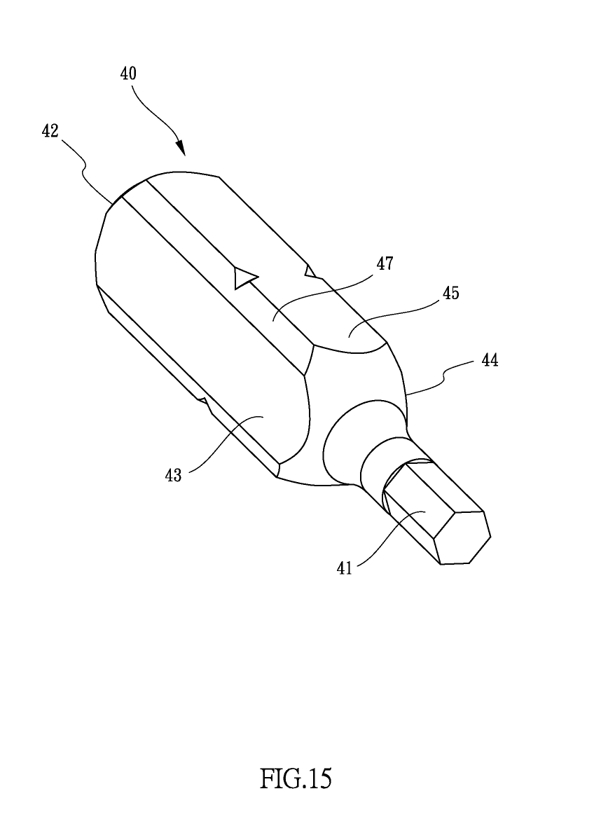

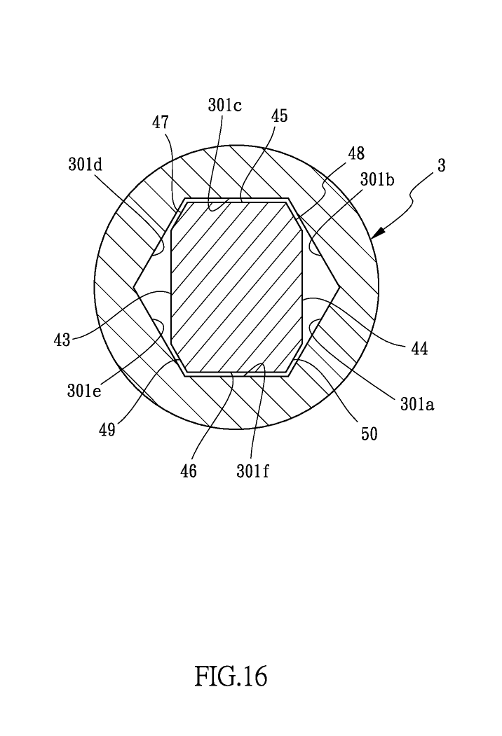

FIGS. 15 and 16 show the third embodiment of the bit 40 of the present invention, wherein the bit 40 has a driving end 41 and a connection end 42 which has a first face 43 and a second face 44 formed on two opposite sides of the body of the bit 40. A first contact portion 45 and a second contact portion 46 are formed on the other two opposite sides of the body of the bit 40. The width of each of the first and second contact portions 45, 46 is the same the width of any of the six sides 301a to 301f of the hexagonal recess 301 of the socket 3. The first contact portion 45 has a third inclined face 47 and a fourth inclined face 48 on two sides thereof The second contact portion 46 has a fifth inclined face 49 and a sixth inclined face 50 on two sides thereof. The width of each of the third, fourth, fifth and sixth inclined faces 47, 48, 49, 50 is smaller than or equal to ½ of any of the six sides 301a to 301f of the hexagonal recess 301 of the socket 3.

When in use, the connection end 42 is inserted into the hexagonal recess 301 of the socket 3. The first contact portion 45 and the second contact portion 46 contact the two sides 301c, 301f of the hexagonal recess 301 of the socket 3. The third and fourth inclined faces 47, 48 contact two sides 301d, 301b between which the side 301c that the first contact portion 45 contacts is located. The fifth and sixth inclined faces 49, 50 contact two sides 301e, 301a between which the side 301f that the second contact portion 46 contacts is located. When the socket 3 is rotated, the driving end 41 of the bit 40 drives the object such as a bolt. The connection end 42 of the bit 40 of the present invention is smaller and lighter so that the bits 40 of the present invention can be carried in a tool box.

While we have shown and described the embodiment in accordance with the present invention, it should be clear to those skilled in the art that further embodiments may be made without departing from the scope of the present invention.

What is claimed is:

1. A hand tool bit comprising:
a bit having a driving end and a connection end which is sized to be inserted into a hexagonal recess of a socket, the connection end having a first face and a second face formed on two opposite sides of a body of the bit, a first contact portion and a second contact portion formed on the other two opposite sides of the body of the bit, the first contact portion having a first inclined face and a second inclined face, the first and second inclined faces intersecting with each other at an angle, the second contact portion having a third inclined face and a fourth inclined face, the third and fourth inclined faces intersecting with each other at an angle, a width of each of the first, second, third and fourth inclined faces being smaller than or equal to ⅔ of any of six sides of the hexagonal recess of the socket.

2. The hand tool bit as claimed in claim 1, wherein the first contact portion and the second contact portion contact any two inner corners of the hexagonal recess of the socket.

3. A hand tool bit comprising:
a bit having a driving end and a connection end which is sized to be inserted into a hexagonal recess of a socket, the connection end having a first face and a second face formed on two opposite sides of a body of the bit, a first contact portion and a second contact portion formed on the other two opposite sides of the body of the bit, the first contact portion and the second contact portion each being a flat surface, a width of each of the first and second contact portions being smaller than or equal to a width of any of six sides of the hexagonal recess of the socket.

4. The hand tool bit as claimed in claim 3, wherein the first contact portion and the second contact portion contact any two of the six sides of the hexagonal recess of the socket.

5. The hand tool bit as claimed in claim 3, wherein the first contact portion has a third inclined face and a fourth inclined face on two sides thereof, the second contact portion has a fifth inclined face and a sixth inclined face on two sides thereof, a width of each of the third, fourth, fifth and sixth inclined faces is smaller than or equal to ½ of any of the six sides of the hexagonal recess of the socket.

6. The hand tool bit as claimed in claim 5, wherein the first contact portion and the second contact portion contact any two sides of the hexagonal recess of the socket, the third and fourth inclined faces contact two sides between which the side that the first contact portion contacts is located, the fifth and sixth inclined faces contact two sides between which the side that the second contact portion contacts is located.
